(19) United States
(12) Patent Application Publication
(10) Pub. No.: US 2021/0147274 A1
(43) Pub. Date: May 20, 2021

(54) POST-DIGESTION AEROBIC TREATMENT FOR SIMULTANEOUS NITROGEN AND PHOSPHOROUS REMOVAL

(71) Applicant: Metro Wastewater Reclamation District, Denver, CO (US)

(72) Inventors: Liam Cavanaugh, Arvada, CO (US); Orren West, Denver, CO (US); Kimberly Cowan, Denver, CO (US); Alex Haeger, Denver, CO (US); Leon Downing, Madison, WI (US)

(73) Assignee: Metro Wastewater Reclamation District, Denver, CO (US)

(21) Appl. No.: 16/689,871

(22) Filed: Nov. 20, 2019

(51) Int. Cl. C02F 11/02; C02F 11/145

(52) U.S. Cl. CPC C02F 11/02; C02F 2101/16; C02F 11/145

(57) ABSTRACT

The present disclosure relates to methods of reducing nitrogen and phosphorus recycled back to a liquid stream by subjecting digested sludge to post aerobic digestion (PAD) in the presence of at least one alkaline compound containing calcium.

### FIELD OF THE INVENTION

The present disclosure relates to methods of reducing nitrogen and phosphorus recycled back to a liquid stream by subjecting digested sludge to post aerobic digestion (PAD) in the presence of at least one alkaline compound containing calcium.

### BACKGROUND OF THE INVENTION

Wastewater treatment is the process of removing contaminants from municipal wastewater. Wastewater, comprised mainly of household sewage and industrial wastewater, contains a variety of inorganic and organic substances. Of these substances, nitrogen and phosphorus are particularly high in wastewater.

Secondary wastewater treatment can remove up to 90% of organic matter in wastewater by using biological treatment processes. Post aerobic digestion (PAD) is a recently developed advanced digestion process where aerobic digestion is designed to follow anaerobic digestion. Following anaerobic digestion, high concentrations of nitrogen and phosphorus are present in the soluble form within the digested sludge. Intermittent or consistent aeration can be used in a post-digestion tank to conduct nitrification and denitrification while consuming alkalinity in the system. The most significant driver for selecting PAD is the reduction of nitrogen recycled back to the liquid stream; however, PAD processes used to date are not effective at removing soluble phosphorus.

Water pollution due to the discharge of nutrients like nitrogen and phosphorus into receiving waters contribute to approximately 25% of all water body impairments (e.g., eutrophication, oxygen depletion, algal growth, ammonia, harmful algal blooms, biological integrity, and turbidity). Nutrients from wastewater have also been linked to: ocean “red tides” that poison fish and cause illness in humans; an increased risk of miscarriages; and methemoglobinemia in infants. Accordingly, wastewater treatment facilities are in need of methods that efficiently reduce both nitrogen and phosphorus recycle back to the liquids stream.

### SUMMARY OF THE INVENTION

A method of reducing nitrogen and phosphorus recycled back to a liquid stream. In an aspect, the method comprises subjecting digested sludge to a post aerobic digestion (PAD) treatment process in the presence of calcium hydroxide. In some embodiments, the PAD treatment process comprises cyclically driving nitritation and denitritation of digested sludge. The nitritation may be driven by ammonium oxidizing bacteria (AOB). The denitritation may be driven by heterotrophic bacteria.

In some embodiments, the PAD treatment process in the presence of calcium hydroxide removes at least 50% of phosphate from the digested sludge. The phosphate may be removed through precipitation of calcium phosphate. In some embodiments, the calcium phosphate precipitate is brushite, hydroxyapatite, or a combination thereof. The calcium phosphate precipitates may be separated from sludge after treatment to produce a separate product.

In some embodiments, the PAD treatment process in the presence of calcium hydroxide decreases PAD effluent orthophosphate concentration compared to the PAD treatment process in the absence of calcium hydroxide. The PAD treatment process in the presence of calcium hydroxide may remove at least 80% of orthophosphate from the PAD effluent. In further embodiments, the PAD treatment process in the presence of calcium hydroxide decreases PAD effluent nitrogen concentration compared to the PAD treatment process in the absence of calcium hydroxide. In some embodiments, the presence of calcium hydroxide stabilizes pH for cyclic nitrification/denitrification. The stabilized pH may range from 5.9 to 6.3.

In some embodiments, the PAD treatment process performed in a PAD reactor tank in the presence of calcium hydroxide decreases a foam layer within the PAD reactor tank compared to the PAD treatment process performed in the PAD reactor tank in the absence of calcium hydroxide. The foam layer within the PAD reactor tank during the PAD treatment process in the presence of calcium hydroxide may be less than 0.1 feet. In some embodiments, the decreased foam layer within the PAD reactor tank during the PAD treatment process in the presence of calcium hydroxide increases operating volume in the PAD reactor tank compared to the operating volume in a PAD rector tank wherein a PAD treatment process in the absence of calcium hydroxide is performed.

In further embodiments, the PAD treatment process performed in the presence of calcium hydroxide stabilizes the nitrogen removal process in the activated sludge system. In additional embodiments, the PAD treatment process performed in the presence of calcium hydroxide reduces reliance on chemical addition at least one tertiary filter compared to the PAD treatment process performed in the absence of calcium hydroxide.

In further embodiments, the PAD treatment process performed in a PAD reactor tank in the presence of calcium hydroxide decreases nitrous oxide emissions from the PAD reactor tank compared to the PAD treatment process performed in the PAD reactor tank in the absence of calcium hydroxide. The PAD treatment process performed in a PAD reactor tank in the presence of calcium hydroxide, in some instances, attenuates greenhouse gas effects by reducing nitrous oxide emissions from the PAD reactor.

### BRIEF DESCRIPTION OF THE FIGURES

FIG. 1 depicts a process flow diagram indicating the flow of water treatment plant processes and equipment. The location of alkalinity addition improvements is indicated at the post aerobic digestion (PAD) reactor.

FIG. 2 depicts a process flow diagram indicating the flow of sludge from the anaerobic digestion reactor into the post aerobic digestion (PAD) reactor where alkalinity and/or carbon are added to balance nitritation kinetics during the PAD process.

FIG. 3 depicts a graph showing the amount of ammonia removed by the post aerobic digestion (PAD) process over time. The graph at Aug. 14, 2017 to Oct. 2, 2017 depicts the amount of ammonia removed as a result of adjustments to cycle times for aeration during PAD. The graph at Oct. 3, 2017 to Sep. 17, 2018 depicts the amount of ammonia removed as a result of addition of magnesium hydroxide during PAD. The graph at Sep. 18, 2018 to Nov. 7, 2018 depicts the amount of ammonia removed as a result of addition of calcium hydroxide (lime) during PAD.

FIG. 4 depicts a graph showing the amount of total phosphorus in sludge solids before (PAD influent) and after (PAD effluent) post aerobic digestion (PAD). The graph at Jun. 1, 2018 to Sep. 8, 2018 depicts the amount of total phosphorus in sludge solids before and after PAD was performed in the presence of magnesium hydroxide. The graph at Sep. 9, 2018 to Dec. 18, 2018 depicts the amount of total phosphorus in sludge solids before and after PAD was performed in the presence of calcium hydroxide (lime). The graph at Sep. 9, 2018 to Dec. 18, 2018 also depicts the amount of orthophosphate (OP) removed from sludge solids when PAD was performed in the presence of calcium hydroxide (lime).

FIG. 5 depicts a graph showing the amount of orthophosphate in sludge solids before (PAD influent) and after (PAD effluent) post aerobic digestion (PAD) and the resulting centrate. The graph at Mar. 1, 2018 to Apr. 1, 2018 depicts the amount of orthophosphate in sludge solids before and after PAD was performed in the presence of continuation aeration without chemical addition. The graph at Apr. 1, 2018 to Sep. 16, 2018 depicts the amount of orthophosphate in sludge solids before and after PAD was performed in the presence of magnesium hydroxide. The graph at Sep. 17, 2018 to Nov. 7, 2018 depicts the amount of orthophosphate in sludge solids before and after PAD was performed in the presence of calcium hydroxide (lime). The graph at Sep. 17, 2018 to Nov. 7, 2018 also depicts the amount of orthophosphate in the centrate when PAD was performed in the presence of calcium hydroxide (lime).

FIG. 6 depicts a graph showing the amount of orthophosphate in sludge solids before (PAD influent) and after (PAD effluent) post aerobic digestion (PAD) and the resulting centrate. The graph at Mar. 1, 2018 to Apr. 1, 2018 depicts the amount of orthophosphate in sludge solids before and after PAD was performed in the presence of continuation aeration without chemical addition. The graph at Apr. 1, 2018 to Sep. 16, 2018 depicts the amount of orthophosphate in sludge solids before and after PAD was performed in the presence of magnesium hydroxide. The graph at Sep. 17, 2018 to Dec. 26, 2018 depicts the amount of orthophosphate in sludge solids before and after PAD was performed in the presence of calcium hydroxide (lime). The graph at Sep. 17, 2018 to Dec. 26, 2018 also depicts the amount of orthophosphate in the centrate when PAD was performed in the presence of calcium hydroxide (lime).

FIG. 7 depicts a graph showing the thickness of the foam layer in the post aerobic digestion (PAD) reactor tank when PAD was performed in the presence of calcium hydroxide (lime) over time.

### DETAILED DESCRIPTION OF THE INVENTION

The present disclosure is based in part on the surprising discovery by the inventors that adding alkalinity compounds which contain calcium (such as calcium hydroxide) during post aerobic digestion (PAD) efficiently removes both nitrogen and phosphorus before recycle to the mainstream of the treatment process, thereby efficiently reducing nitrogen and phosphorus recycled back to a liquid stream. Accordingly, the present disclosure provides methods for post aerobic digestion (PAD) process in the presence of calcium hydroxide to expectantly increase the amounts of nitrogen and phosphate removal post anaerobic digestion. Use of the methods disclosed herein provides stable operation of the PAD process and improve water and biosolid treatment and handling.

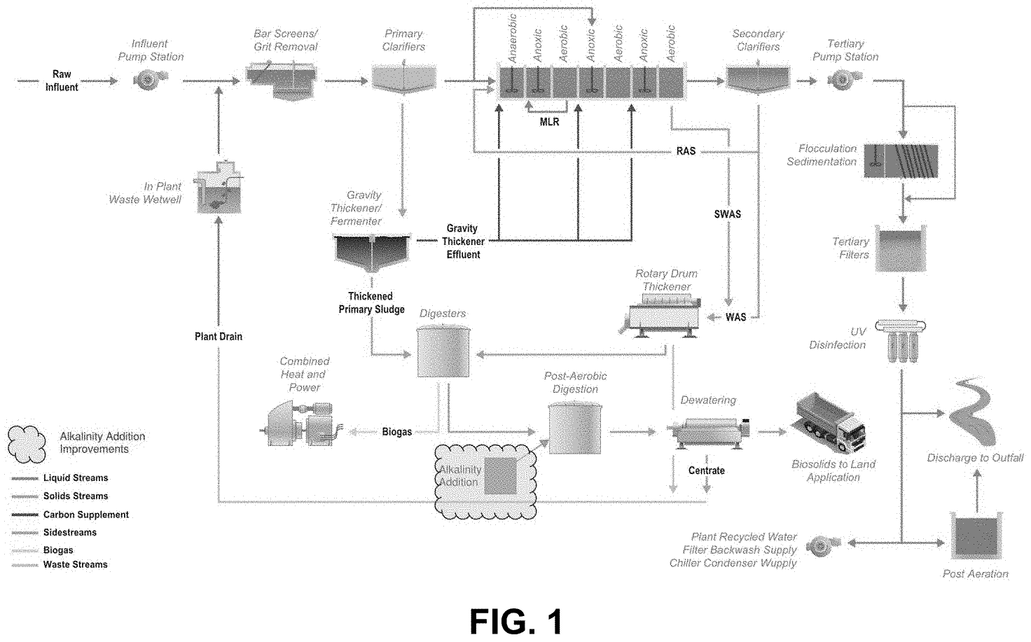

The present disclosure provides methods that improve water and biosolid treatment and handling. The process flow diagram in FIG. 1 provides a non-limiting example of water treatment plant processes and equipment that can be used water and biosolid treatment and handling. In brief, raw influent can be pumped into a facility and passed over bar screens to remove large objects from the wastewater, helping to prevent clogging of pipes and damaging the treatment equipment. Wastewater can next flow through a channel, allowing dense, inorganic material to settle on the bottom. Scrapers, hoppers and clam buckets are non-limiting methods to remove the collected grits. Once the grit is removed, wastewater can flow into large settling tanks, or primary clarifiers, that allow suspended solids and organic material to sink to the bottom of the tank. As used herein, the suspended solids and organic material to sink to the bottom of the tank are referred to as “sludge.” Next, large aeration basins or tanks can mix the partially treated wastewater with oxygen. Return Activated Sludge (RAS) can then bring sludge back to the aeration process for further treatment while Waste Activated Sludge (WAS) can remove the excess or older sludge. The cleanest wastewater can be drawn from the top of the aeration tanks through spillways into a tank for secondary clarification. While in the tank, suspended particles can settle to the bottom and are removed by scrapers or hoppers. The cleanest water can be drawn from the surface of the tank and pumped through tertiary filters followed by disinfection with ultra-violet light to kill bacteria.

Sludge from the final settling tanks can be collected from the bottom of the tanks and pumped to the primary settling tank. In some embodiments, sludge from the final settling tanks can have high water content. In some aspects, sludge from the final settling tanks may contain about 40% to about 100%, about 50% to about 90%, or about 60% to about 80% water. A gravity belt thickener, a rotary drum thickener, or a fermenter are all non-limiting examples of processes that can be used to reduce the amount of water in the sludge before further treatment. In some embodiments, the amount of water removed from the sludge may be about 25% to about 100%, about 35% to about 85% or about 45% to about 75%.

A goal of further processing sludge is to reduce the amount of sludge that needs to be disposed. In some embodiments disclosed herein, a method for sludge treatment is anaerobic digestion. As used herein, “anaerobic digestion” is a collection of processes by which microorganisms break down organic matter contained within the sludge in the absence of gaseous oxygen. In some embodiments, anaerobic digestion yield gaseous products that have the potential for reuse. Non-limiting examples of gaseous products can include carbon dioxide (CO₂), methane (CH₄), hydrogen (H₂), nitrogen (N₂), oxygen (O₂), O₂⁻, hydrogen sulfide (H₂S), water (H₂O), hydroxide (OH—), and hydrogen peroxide (H₂O₂). In some aspects, gaseous products can primarily include carbon dioxide (CO₂), methane (CH₄). In some other aspects, gaseous products can encompass about 50% methane to about 75% methane, about 55% methane to about 70% methane, or about 60% methane to about 65% methane. In still other aspects, gaseous products can encompass about 20% carbon dioxide to about 45% carbon dioxide, about 25% carbon dioxide to about 40% carbon dioxide, or about 30% carbon dioxide to about 35% carbon dioxide. In some other aspects, the collective gaseous products are referred to herein as “biogas.” In still other aspects, biogas can be a high energy fuel.

In some embodiments, microorganisms used in anaerobic digestion can involve at least one bacteria. In some aspects, bacteria used in anaerobic digestion as disclosed herein may include hydrolytic bacteria, acidogenic bacteria, acetogenic bacteria, methanogenic bacteria, and a combination thereof. In other aspects, bacteria used in anaerobic digestion as disclosed herein may be of the genera Methanosarcina Methanosaeta, Clostridium, Bifidobacterium, Bacteroides, or combinations thereof. In still other aspects, bacteria used in anaerobic digestion as disclosed herein may range from about 10¹ CFU/mL (colony-forming units per milliliter) to about 10¹⁰ CFU/mL, from about 10² CFU/mL to about 10⁹ CFU/mL, or from about 10³ CFU/mL to about 10⁷ CFU/mL. In some aspects, bacteria used in anaerobic digestion as disclosed herein may be about 10¹ CFU/mL, about 10² CFU/mL, about 10³ CFU/mL, about 10⁴ CFU/mL, about 10⁵ CFU/mL, about 10⁶ CFU/mL, about 10⁷ CFU/mL, about 10⁸ CFU/mL, about 10⁹ CFU/mL, or about 10¹⁰ CFU/mL.

In some embodiments disclosed herein anaerobic digestion can occur for at least about 1 day to at least about 40 days, at least about 5 days to at least about 30 days, or at least about 10 days to at least about 20 days. In some aspects, anaerobic digestion can occur for at least about 1 day, at least about 5 days, at least about 10 days, at least about 20 days, at least about 30 days, or at least about 40 days.

In some embodiments disclosed herein, anaerobic digestion can occur at a constant temperature for the duration of digestion. In some aspects, anaerobic digestion can occur at about 25° C. to about 50° C., about 30° C. to about 45° C., or about 35° C. to about 40° C. for the duration of digestion. In some other aspects, anaerobic digestion can occur at about 25° C., about 30° C., about 35° C., about 40° C., about 45° C., or about 50° C. for the duration of digestion. In some embodiments disclosed herein, anaerobic digestion can occur at increasing temperatures for the duration of digestion. In some aspects, anaerobic digestion can occur at increasing temperatures ranging from about 25° C. to about 50° C., about 30° C. to about 45° C., or about 35° C. to about 40° C. In some embodiments disclosed herein, anaerobic digestion can occur at decreasing temperatures for the duration of digestion. In some aspects, anaerobic digestion can occur at decreasing temperatures ranging from about 50° C. to about 25° C., about 45° C. to about 30° C., or about 40° C. to about 35° C.

In some embodiments, anaerobic digestion can occur at high dissolved oxygen levels. As used herein, the term “dissolved oxygen” or “DO” refers to the amount of oxygen that is present in a solution. In some aspects, anaerobic digestion may occur at dissolved oxygen levels ranging from about 2 mg/L to about 20 mg/mL, from about 3 mg/L to about 15 mg/mL, or from about 4 mg/L to about 10 mg/mL. In some other aspects, anaerobic digestion may occur at dissolved oxygen levels of at least 2 mg/mL, at least 5 mg/mL, at least 10 mg/mL, at least 15 mg/mL, or at least 20 mg/mL.

In some embodiments disclosed herein, digested sludge can contain high concentrations of nitrogen, phosphorous, or a combination of nitrogen and phosphorous after anaerobic digestion. In some embodiments disclosed herein, nitrogen contained in digested sludge after anaerobic digestion can be inorganic, organic, or a combination thereof. In other aspects, nitrogen contained in digested sludge can be soluble. In still other aspects, nitrogen contained in digested sludge can be ammonia (NH₃), ammonium (NH₄), nitrate (NO₃), nitrite (NO₂) or a combination thereof. As used herein, the terms “ammonia” and “ammonium” may be used interchangeably and are understood to encompass both NH₃ and NH₄. Total Kjeldahl Nitrogen (TKN) is a U.S. EPA-approved parameter used to measure the sum of organic nitrogen and ammonia concentrations. In some aspects, TKN of digested sludge may be at least about 500 milligrams of nitrogen per liter (mg-N/L) to at least about 2,500 mg-N/L after anaerobic digestion. In some other aspects, TKN of digested sludge may be at least about 500 mg-N/L, at least about 750 mg-N/L, at least about 1,000 mg-N/L, at least about 1,250 mg-N/L, at least about 1,500 mg-N/L, at least about 1,750 mg-N/L, at least about 2,000 mg-N/L, at least about 2,250 mg-N/L, or at least about 2,500 mg-NIL after anaerobic digestion. Total inorganic nitrogen (TIN) is used herein to measure the sum of ammonia, nitrate, and nitrite concentrations. In some aspects, TIN of digested sludge may be at least about 500 mg-N/L to at least about 2,500 mg-N/L after anaerobic digestion. In some other aspects, TIN of digested sludge may be at least about 500 mg-N/L, at least about 750 mg-N/L, at least about 1,000 mg-N/L, at least about 1,250 mg-N/L, at least about 1,500 mg-N/L, at least about 1,750 mg-N/L, at least about 2,000 mg-N/L, at least about 2,250 mg-N/L, or at least about 2,500 mg-N/L after anaerobic digestion. As used herein, “total nitrogen” or “TN” is a measurement of all forms of nitrogen in a sample. TN can be a sum of ammonia, nitrate, nitrite, and organic nitrogen. In some aspects, TN of digested sludge may be at least about 500 mg-N/L to at least about 2,500 mg-N/L after anaerobic digestion. In some other aspects, TN of digested sludge may be at least about 500 mg-N/L, at least about 750 mg-N/L, at least about 1,000 mg-N/L, at least about 1,250 mg-N/L, at least about 1,500 mg-N/L, at least about 1,750 mg-N/L, at least about 2,000 mg-N/L, at least about 2,250 mg-N/L, or at least about 2,500 mg-N/L after anaerobic digestion. In some aspects, digested sludge may contain at least about 500 mg-N/L ammonia to at least about 2,500 mg-N/L ammonia after anaerobic digestion. In some aspects, digested sludge may contain up to about 0.1 mg-N/L nitrate to up to about 60 mg-N/L nitrate after anaerobic digestion.

In some embodiments disclosed herein, phosphorous contained in digested sludge after anaerobic digestion can be inorganic, organic, or a combination thereof. In other aspects, phosphorous contained in digested sludge can be soluble. In still other aspects, phosphorous contained in digested sludge can be phosphates (PO₄). In some aspects, phosphates contained in digested sludge can be orthophosphates, condensed phosphates, organic phosphates or a combination thereof. As used herein, “total phosphorous” or “TP” is a measurement of all forms of phosphorus in a sample. TP can be a sum of orthophosphates, condensed phosphates, and organic phosphates. In some aspects, TP of digested sludge may be at least about 35,000 μg/g to at least about 55,000 μg/g after anaerobic digestion. In some other aspects, TP of digested sludge may be at least about 35,000 μg/g, at least about 40,000 μg/g, at least about 45,000 μg/g, at least about 50,000 μg/g, or at least about 55,000 μg/g after anaerobic digestion. In other aspects, soluble phosphorous contained in digested sludge can be orthophosphates. In some aspects, orthophosphates of digested sludge may be at least about 500 milligrams of phosphorous per liter (mg-P/L) to at least about 2,500 mg-P/L after anaerobic digestion. In some other aspects, orthophosphates of digested sludge may be at least about 500 mg-P/L, at least about 750 mg-P/L, at least about 1,000 mg-P/L, at least about 1,250 mg-P/L, at least about 1,500 mg-P/L, at least about 1,750 mg-P/L, at least about 2,000 mg-P/L, at least about 2,250 mg-P/L, or at least about 2,500 mg-P/L after anaerobic digestion.

As used herein, the term “sidestream” refers to any flow stream resulting from the treatment of sludge that is returned for further treatment after anaerobic digestion. Sidestream flow streams at facilities with anaerobic digestion can be targeted for nutrient removal because such facilities tend to exhibit relatively small flow with concentrated nutrient loading back to the liquid treatment train. Accordingly, the present disclosure provides sidestream treatment methods for the further treatment of digested sludge following anaerobic digestion. Specifically, the present disclosure provides post aerobic digestion (PAD) treatment methods for the further treatment of digested sludge following anaerobic digestion. In some embodiments, PAD methods disclosed herein unexpectedly reduce both nitrogen and phosphorus loading back to the liquid treatment train.

As used herein the term “post aerobic digestion” or “PAD” refers to a sidestream treatment technology that encompasses an advanced digestion process, where an aerobic digestion step follows anaerobic digestion. The term “PAD influent” as used herein refers to the digested sludge following anaerobic digestion before entering the aerobic digestion step encompassed by PAD treatment. Accordingly, the terms “digested sludge” and “PAD influent” are understood to have equal meaning throughout the disclosure herein. The term “PAD effluent” as used herein refers to the resulting sludge after completion of the PAD treatment.

In some embodiments disclosed herein, PAD treatment encompasses aerobic digestion. As used herein, “aerobic digestion” is a collection of processes by which microorganisms break down organic matter contained within the sludge in the presence of gaseous oxygen. In some embodiments, aerobic digestion may occur in a PAD reactor. In some aspects, a PAD reactor can be equipped with at least one mixer. In some other aspects, a PAD reactor can be equipped with an aeration system. In some aspects, an aeration system may employ at least one surface aerator. In some other aspects, a surface aerator may be an impeller, a paddle, or a combination thereof. In some aspects, an aeration system may employ at least one submerged aerator. In some other aspects, a submerged aerator may be a blower, a bubble diffuser, a jet aerator, a Venturi injector, or a combination thereof. In still some other aspects, a submerged aerator may be a coarse bubble diffuser, a fine bubble diffuser, or a combination thereof. In some aspects, an aeration system may employ surface aerators, submerged aerators, or a combination thereof. In still some other aspects, an aeration system can generate gas bubbles with diameters ranging from about 1 nm to about 1 mm, about 10 nm to about 100 μm, or about 100 nm to about 1 μm. In some aspects, an aeration system may deliver air to a PAD reactor. In some other aspects, an aeration system may deliver oxygen to a PAD reactor. In still some other aspects, an aeration system may deliver oxygen to a PAD reactor where the oxygen can be about 80% to about 100% pure, about 85% to about 99% pure, or about 90% to about 98% pure. In some other aspects, an aeration system can run at specific time intervals. In some aspects, an aeration system can run continuously. In some other aspects, an aeration system can run intermittently. In some other aspects, an aeration system can run on a cyclic aeration schedule.

In some embodiments, aerobic digestion may occur in a PAD reactor at low dissolved oxygen levels (DO). In some aspects, aerobic digestion may occur in a PAD reactor at dissolved oxygen levels ranging from about 0.1 mg/L to about 3.0 mg/mL, from about 0.5 mg/L to about 2.5 mg/mL, or from about 1 mg/L to about 2 mg/mL. In some other aspects, aerobic digestion may occur in a PAD reactor at dissolved oxygen levels of about 0.5 mg/mL, about 1.0 mg/mL, about 1.5 mg/mL, about 2.0 mg/mL, or about 2.5 mg/mL.

In some other aspects, dissolved oxygen in the PAD reactor can be regulated by an aeration system. In some other aspects, an aeration system may be equipped to monitor DO levels in a PAD reactor. In still some other aspects, an aeration system may be equipped a probe to measure DO levels in a PAD reactor. In yet some other aspects, an aeration system equipped to monitor DO levels in a PAD reactor may increase air into the PAD reactor after DO levels drop below a setpoint. In some other aspects, an aeration system equipped to monitor DO levels in a PAD reactor may decrease air into the PAD reactor after DO levels rise above a setpoint.

In some other aspects, an aeration system may run at specific time intervals to maintain DO levels in a PAD reactor. In some aspects, a cyclic aeration schedule may maintain DO levels in a PAD reactor. In some aspects, a cyclic aeration schedule may be about 120 minutes to about 60 minutes of aeration followed by about by about 60 minutes to about 5 minutes of no aeration to generate a dissolved oxygen concentration ranging from about 0.5 mg/L to about 2.5 mg/L. In some other aspects, a cyclic aeration schedule may be about 90 minutes of aeration followed by about by about 30 minutes of no aeration to generate a dissolved oxygen concentration ranging from about 1.0 mg/L to about 2.0 mg/L.

In some embodiments, PAD influent can be subjected to aerobic digestion in a PAD reactor. In some aspects, PAD influent can be subjected to nitrification, denitrification, or both nitrification and denitrification in a PAD reactor.

Nitrification is a microbially facilitated process that leads to oxidation of ammonia to nitrate via nitrite. In some aspects, nitrification of PAD influent is by at least one microorganism. In some aspects, nitrification of PAD influent is by at least one ammonium oxidizing bacteria (AOB). In some other aspects, one or more AOB belong to the Proteobacteria phylum. In still some other aspects, one or more AOB belong to the beta-proteobacteria subgroup. In yet some other aspects, one or more AOB belong to the gamma-proteobacteria subgroup. In some aspects, one or more AOB belong to the genera Nitrosomonas, Nitrosovibrio, Nitrosolobus, Nitrosospira, Nitrosococcus, or a combination thereof. In some other aspects, nitrification of PAD influent is by Nitrosomonas oligotropha, Nitrosomonas europaea, Nitrosomonas nitrosa, or a combination thereof.

In some embodiments, the amount of AOB used in the PAD process as disclosed herein may range from about 10¹ CFU/mL to about 10¹⁰ CFU/mL, from about 10² CFU/mL to about 10⁹ CFU/mL, or from about 10³ CFU/mL to about 10⁷ CFU/mL. In some aspects, the amount of AOB used in the PAD process as disclosed herein may be about 10¹ CFU/mL, about 10² CFU/mL, about 10³ CFU/mL, about 10⁴ CFU/mL, about 10⁵ CFU/mL, about 10⁶ CFU/mL, about 10⁷ CFU/mL, about 10⁸ CFU/mL, about 10⁹ CFU/mL, or about 10¹⁰ CFU/mL.

Denitrification is a microbially facilitated process where nitrate is reduced and ultimately produces molecular nitrogen (N₂) in the form of nitrous oxides and nitrogen gas products. In some aspects, denitrification of PAD influent is by at least one microorganism. In some aspects, nitrification of PAD influent is by at least one heterotrophic bacteria. In some other aspects, one or more heterotrophic bacteria belong to the Pseudomonadaceae family. In still some other aspects, one or more heterotrophic bacteria belong to Pseudomonas spp. In yet some other aspects, one or more heterotrophic bacteria belong to the genera Achromobacter, Pseudomonas, Pasteurella, Paracoccus, Flavobacterium, Aeromonas, Agrobacterium, Cedecia, Chromobacterium, Citrobacter, Enterobacter, Escherichia, Klebsiella, Moraxella, Rahnella, Serratia, Vibrio, Yersinia, or a combination thereof. In some other aspects, denitrification of PAD influent is by Achromobacter xylosoxidans, Flavobacterium indologenes, Pasteurella spp., Pseudomonas aeruginosa, Pseudomonas fluorescens 1, Pseudomonas fluorescens 2, Pseudomonas mallei, Pseudomonas pickettii, Pseudomonas stutzeri, Pseudomonas testosteroni, Pseudomonas alcaligenes, or a combination thereof.

In some embodiments, the amount of heterotrophic bacteria used in the PAD process as disclosed herein may range from about 10¹ CFU/mL to about 10¹⁰ CFU/mL, from about 10² CFU/mL to about 10⁹ CFU/mL, or from about 10³ CFU/mL to about 10⁷ CFU/mL. In some aspects, the amount of heterotrophic bacteria used in the PAD process as disclosed herein may be about 10¹ CFU/mL, about 10² CFU/mL, about 10³ CFU/mL, about 10⁴ CFU/mL, about 10⁵ CFU/mL, about 10⁶ CFU/mL, about 10⁷ CFU/mL, about 10⁸ CFU/mL, about 10⁹ CFU/mL, or about 10¹⁰ CFU/mL.

In some embodiments, the total amount of AOB and heterotrophic bacteria used in the PAD process as disclosed herein may range from about 10¹ CFU/mL to about 10¹⁰ CFU/mL, from about 10² CFU/mL to about 10⁹ CFU/mL, or from about 10³ CFU/mL to about 10⁷ CFU/mL. In some aspects, the total amount of AOB and heterotrophic bacteria used in the PAD process as disclosed herein may be about 10¹ CFU/mL, about 10² CFU/mL, about 10³ CFU/mL, about 10⁴ CFU/mL, about 10⁵ CFU/mL, about 10⁶ CFU/mL, about 10⁷ CFU/mL, about 10⁸ CFU/mL, about 10⁹ CFU/mL, or about 10¹⁰ CFU/mL.

In some embodiments, PAD influent can be subjected to aerobic digestion in a PAD reactor with a solids retention time (SRT) of at least about 2 days to at least about 10 days, at least about 3 days to at least about 9 days, at least about 4 days to at least about 8 days, or at least about 5 days to at least about 7 days. As used herein, the term “solids retention time” refers to the average time the PAD influent is in the PAD reactor.

In some embodiments disclosed herein, PAD influent can be subjected to aerobic digestion at a constant temperature for the duration of digestion. In some aspects, aerobic digestion can occur at about 10° C. to about 50° C., about 15° C. to about 45° C., or about 20° C. to about 40° C. for the duration of digestion. In some other aspects, aerobic digestion can occur at about 10° C., about 15° C., about 20° C., about 25° C., about 30° C., about 35° C., or about 40° C. for the duration of digestion. In some embodiments disclosed herein, aerobic digestion can occur at increasing temperatures for the duration of digestion. In some aspects, aerobic digestion can occur at increasing temperatures ranging from about 10° C. to about 50° C., about 15° C. to about 45° C., or about 20° C. to about 40° C. In some embodiments disclosed herein, aerobic digestion can occur at decreasing temperatures for the duration of digestion. In some aspects, anaerobic digestion can occur at decreasing temperatures ranging from about 50° C. to about 10° C., about 45° C. to about 15° C., or about 40° C. to about 20° C.

Alkalinity is a chemical requirement for nitrification of PAD influent. During the nitrification process by AOB, ammonia conversion to nitrate yields hydrogen ions. Accordingly, alkalinity is consumed as the released hydrogen ions are neutralized, generating acid. In addition, nitrification of PAD influent by AOB is pH-sensitive and rates of nitrification will decline significantly at low pH values. As such, nitrification can be limited by the availability of alkalinity in the PAD reactor. For example, but not limited to, during operational periods where alkalinity limits nitrification in the PAD reactor (through both bicarbonate limitation and pH dropping below 6.0), only about 50% to about 70% of the PAD influent ammonium is nitrified.

In some embodiments, alkalinity may be added to the PAD process disclosed herein. In some aspects, alkalinity may be added to the PAD reactor at least about once a day, at least about three times a day, at least about 5 times a day, or at least about 10 times a day. In some aspects, alkalinity may be added to the PAD reactor by a chemical dosing pump. In some other aspects, alkalinity may be added to the PAD reactor by a chemical dosing pump with a flow rate ranging from about 0.05 gallon per minute (gpm) to about 1.00 gpm, from about 0.07 gpm to about 0.98 gpm, or from about 0.09 gpm to about 0.9 gpm. In still some other aspects, alkalinity may be added to the PAD reactor by a chemical dosing pump with a flow rate ranging from about 0.09 gpm to about 0.98 gpm. In some aspects, alkalinity may be added to the PAD reactor in an average daily volume of about 0.03 gallons alkalinity per gallon of PAD influent to about 0.05 gallons alkalinity per gallon of PAD influent, about 0.035 gallons alkalinity per gallon of PAD influent to about 0.045 gallons alkalinity per gallon of PAD influent, or about 0.04 gallons alkalinity per gallon of PAD influent to about 0.042 gallons alkalinity per gallon of PAD influent.

In some embodiments, at least one chemical may be added to the PAD process to supplement alkalinity. In some aspects, a chemical used to supplement alkalinity as disclosed herein can be an alkali. As used herein, the term “alkali” refers to a basic, ionic salt of an alkali metal or alkaline earth metal chemical element. In some other aspects, a chemical used to supplement alkalinity as disclosed herein can be an alkali salt. In some other aspects, chemicals used to supplement alkalinity as disclosed herein can be ammonium bicarbonate (NH₄HCO₃), (sodium hydroxide (NaOH), sodium carbonate (Na₂CO₃), sodium bicarbonate (NaHCO₃), potassium hydroxide (KOH), calcium oxide (CaO), calcium hydroxide (Ca(OH)₂), magnesium oxide (MgO), magnesium hydroxide (Mg(OH)₂), magnesium carbonate (MgCO₃), magnesium bicarbonate (Mg(HCO₃)₂), expired beer, or a combination thereof. In some aspects, chemicals used to supplement alkalinity as disclosed herein are calcium alkalis. As used herein, the term “calcium alkali” refers to an alkaline compound containing calcium. In some preferred embodiments, chemicals used to supplement alkalinity as disclosed herein are magnesium hydroxide, calcium hydroxide, or a combination thereof. In preferred aspects, a chemical used to supplement alkalinity as disclosed herein is calcium hydroxide.

In some embodiments, alkalinity may be added during the PAD process disclosed herein to stabilize the pH level in the PAD reactor. In some aspects, alkalinity can be added to stabilize a pH level of about 6.0 to about 7.2, about 6.2 to about 7.1, or about 6.3 to about 7.0 in the PAD reactor. In some other aspects, alkalinity can be added to stabilize a pH level of about 6.0, about 6.3, about 6.6, about 6.9, or about 7.2. In some preferred embodiments, alkalinity may be added during the PAD process disclosed herein to stabilize the pH level from about 5.9 to about 6.3. In some other aspects, at least one calcium alkali may be added during the PAD process disclosed herein to stabilize the pH level from about 5.9 to about 6.3. In some other aspects, calcium hydroxide may be added during the PAD process disclosed herein to stabilize the pH level from about 5.9 to about 6.3.

In still some embodiments, alkalinity may be added during the PAD process disclosed herein to maintain a pH level suitable for calcium and/or phosphate precipitation. In some aspects, alkalinity may be added during the PAD process disclosed herein to maintain a pH level suitable for calcium and/or phosphate precipitation as one or more calcium phosphate compound species. Non-limiting examples of calcium phosphate compound species that can be precipitated due to alkalinity addition to the PAD process disclosed herein include octacalcium phosphate (Ca₈(HPO₄)₂(PO₄)₄.5H₂O)), amorphous calcium phosphate (Ca₃(PO₄)₂.xH₂O), monetite (CaHPO₄), whitlockite (Ca₉(MgFe)(PO₄)₆PO₃OH), tricalcium phosphate (Ca₃(PO₄)₂), brushite (CaHPO₄.2H₂O), and hydroxyapatite (Ca₅(PO₄)₃(OH)). In some aspects, alkalinity may be added during the PAD process disclosed herein to maintain a pH level suitable to precipitate brushite, hydroxyapatite, or a combination thereof from the PAD influent. In some aspects, alkalinity may be added during the PAD process disclosed herein to maintain a pH level suitable to precipitate only to precipitate brushite, hydroxyapatite, or a combination thereof and no other calcium phosphate species from the PAD influent. In some other aspects, alkalinity may be added during the PAD process disclosed herein to maintain a pH level of about 6.0 to about 7.0 or about 6.3 to about 6.9 to precipitate only brushite, hydroxyapatite, or a combination thereof and no other calcium phosphate compound species from the PAD influent. In some other aspects, at least one calcium alkali may be added during the PAD process disclosed herein to maintain a pH level of about 6.0 to about 7.0 or about 6.3 to about 6.9 to precipitate only brushite, hydroxyapatite, or a combination thereof and no other calcium phosphate species from the PAD influent. In some preferred aspects, calcium hydroxide may be added during the PAD process disclosed herein to maintain a pH level of about 6.0 to about 7.0 or about 6.3 to about 6.9 to precipitate only brushite, hydroxyapatite, or a combination thereof and no other calcium phosphate species from the PAD influent.

In still some other aspects, alkalinity may be added during the PAD process disclosed herein to maintain a pH level that does not result in scaling of equipment. In yet some other aspects, alkalinity may be added during the PAD process disclosed herein to maintain a pH level of about 6.0 to about 7.0 or about 6.3 to about 6.9 to prevent the scaling of equipment. In some other aspects, at least one calcium alkali may be added during the PAD process disclosed herein to maintain a pH level of about 6.0 to about 7.0 or about 6.3 to about 6.9 to prevent the scaling of equipment. In some preferred aspects, calcium hydroxide may be added during the PAD process disclosed herein to maintain a pH level of about 6.0 to about 7.0 or about 6.3 to about 6.9 to prevent the scaling of equipment.

In still some other aspects, alkalinity may be added during the PAD process disclosed herein to maintain a pH level that reduces nitrous oxide emissions from the PAD reactor. In yet some other aspects, alkalinity may be added during the PAD process disclosed herein to maintain a pH level of about 6.0 to about 7.0 or about 6.3 to about 6.9 to reduce nitrous oxide emissions from the PAD reactor. In some other aspects, at least one calcium alkali may be added during the PAD process disclosed herein to maintain a pH level of about 6.0 to about 7.0 or about 6.3 to about 6.9 to reduce nitrous oxide emissions from the PAD reactor. In some preferred aspects, calcium hydroxide may be added during the PAD process disclosed herein to maintain a pH level of about 6.0 to about 7.0 or about 6.3 to about 6.9 to reduce nitrous oxide emissions from the PAD reactor.

In some other aspects, alkalinity may be added during the PAD process disclosed herein to maintain a pH level that attenuates greenhouse gas effects by reducing nitrous oxide emissions from the PAD reactor. In yet some other aspects, alkalinity may be added during the PAD process disclosed herein to maintain a pH level of about 6.0 to about 7.0 or about 6.3 to about 6.9 to attenuate greenhouse gas effects by reducing nitrous oxide emissions from the PAD reactor. In some other aspects, at least one calcium alkali may be added during the PAD process disclosed herein to maintain a pH level of about 6.0 to about 7.0 or about 6.3 to about 6.9 to attenuate greenhouse gas effects by reducing nitrous oxide emissions from the PAD reactor. In some preferred aspects, calcium hydroxide may be added during the PAD process disclosed herein to maintain a pH level of about 6.0 to about 7.0 or about 6.3 to about 6.9 to attenuate greenhouse gas effects by reducing nitrous oxide emissions from the PAD reactor.

In some embodiments disclosed herein, PAD effluent contains low concentrations of nitrogen, phosphorous, or a combination of nitrogen and phosphorous after PAD treatment. In some aspects, nitrogen contained in PAD effluent can be inorganic, organic, or a combination thereof. In some other aspects, nitrogen contained in PAD effluent can be soluble. In still other aspects, nitrogen contained in PAD effluent can be ammonia, nitrate, nitrite, or a combination thereof. In some aspects, TKN of PAD effluent may be at least about 0 mg-N/L to at least about 250 mg-N/L after PAD treatment. In some other aspects, TKN of PAD effluent may be at least about 1 mg-N/L, at least about 75 mg-N/L, at least about 100 mg-N/L, at least about 125 mg-N/L, at least about 150 mg-N/L, at least about 175 mg-N/L, at least about 200 mg-N/L, at least about 225 mg-N/L, or at least about 250 mg-N/L after PAD treatment. In some embodiments, PAD treatment as disclosed herein removes about 80% TKN to about 100% TKN, about 85% TKN to about 99% TKN, or about 90% to about 98% TKN from PAD influent. In some embodiments, PAD treatment as disclosed herein removes about 80% TKN, about 85% TKN, about 90% TKN, about 95% TKN, about 96% TKN, about 97% TKN, about 98% TKN, about 99% TKN, or about 100% TKN from PAD influent.

In some aspects, TKN of PAD effluent may be at least about 0 mg-NIL to at least about 250 mg-N/L after at least one calcium alkali is added to control alkalinity during PAD treatment as disclosed herein. In some other aspects, TKN of PAD effluent may be at least about 1 mg-N/L, at least about 75 mg-N/L, at least about 100 mg-N/L, at least about 125 mg-N/L, at least about 150 mg-N/L, at least about 175 mg-N/L, at least about 200 mg-N/L, at least about 225 mg-N/L, or at least about 250 mg-N/L after at least one calcium alkali is added to control alkalinity during PAD treatment as disclosed herein. In some embodiments, after at least one calcium alkali is added to control alkalinity during PAD treatment as disclosed herein, about 80% TKN to about 100% TKN, about 85% TKN to about 99% TKN, or about 90% to about 98% TKN may be removed from PAD influent. In some embodiments, after at least one calcium alkali is added to control alkalinity during PAD treatment as disclosed herein, 80% TKN, about 85% TKN, about 90% TKN, about 95% TKN, about 96% TKN, about 97% TKN, about 98% TKN, about 99% TKN, or about 100% TKN may be removed from PAD influent.

In some aspects, TKN of PAD effluent may be at least about 0 mg-NIL to at least about 250 mg-N/L after calcium hydroxide is added to control alkalinity during PAD treatment as disclosed herein. In some other aspects, TKN of PAD effluent may be at least about 1 mg-N/L, at least about 75 mg-N/L, at least about 100 mg-N/L, at least about 125 mg-N/L, at least about 150 mg-N/L, at least about 175 mg-N/L, at least about 200 mg-N/L, at least about 225 mg-N/L, or at least about 250 mg-N/L after calcium hydroxide is added to control alkalinity during PAD treatment as disclosed herein. In some embodiments, after calcium hydroxide is added to control alkalinity during PAD treatment as disclosed herein, about 80% TKN to about 100% TKN, about 85% TKN to about 99% TKN, or about 90% to about 98% TKN may be removed from PAD influent. In some embodiments, after calcium hydroxide is added to control alkalinity during PAD treatment as disclosed herein, 80% TKN, about 85% TKN, about 90% TKN, about 95% TKN, about 96% TKN, about 97% TKN, about 98% TKN, about 99% TKN, or about 100% TKN may be removed from PAD influent.

In some embodiments, TIN of PAD effluent may be at least about 0 mg-N/L to at least about 500 mg-N/L after PAD treatment as disclosed herein. In some other aspects, TIN of digested sludge may be at least about 0 mg-N/L, at least about 50 mg-N/L, at least about 100 mg-N/L, at least about 150 mg-N/L, at least about 200 mg-NIL, at least about 250 mg-N/L, at least about 300 mg-N/L, at least about 400 mg-N/L, or at least about 500 mg-N/L after PAD treatment as disclosed herein. In some embodiments, PAD treatment as disclosed herein removes about 80% TIN to about 100% TIN, about 85% TIN to about 99% TIN, or about 90% to about 98% TIN from PAD influent. In some embodiments, PAD treatment as disclosed herein removes about 80% TIN, about 85% TIN, about 90% TIN, about 95% TIN, about 96% TIN, about 97% TIN, about 98% TIN, about 99% TIN, or about 100% TIN from PAD influent.

In some embodiments, TIN of PAD effluent may be at least about 0 mg-N/L to at least about 500 mg-N/L after at least one calcium alkali is added to control alkalinity during PAD treatment as disclosed herein. In some other aspects, TIN of digested sludge may be at least about 0 mg-N/L, at least about 50 mg-N/L, at least about 100 mg-N/L, at least about 150 mg-N/L, at least about 200 mg-N/L, at least about 250 mg-N/L, at least about 300 mg-N/L, at least about 400 mg-N/L, or at least about 500 mg-N/L after at least one calcium alkali is added to control alkalinity during PAD treatment as disclosed herein. In some embodiments, after at least one calcium alkali is added to control alkalinity during PAD treatment as disclosed herein, 80% TIN to about 100% TIN, about 85% TIN to about 99% TIN, or about 90% to about 98% TIN may be removed from PAD influent. In some embodiments, after at least one calcium alkali is added to control alkalinity during PAD treatment as disclosed herein, 80% TIN, about 85% TIN, about 90% TIN, about 95% TIN, about 96% TIN, about 97% TIN, about 98% TIN, about 99% TIN, or about 100% TIN may be removed from PAD influent.

In some embodiments, TIN of PAD effluent may be at least about 0 mg-N/L to at least about 500 mg-N/L after calcium hydroxide is added to control alkalinity during PAD treatment as disclosed herein. In some other aspects, TIN of digested sludge may be at least about 0 mg-N/L, at least about 50 mg-N/L, at least about 100 mg-N/L, at least about 150 mg-N/L, at least about 200 mg-N/L, at least about 250 mg-N/L, at least about 300 mg-N/L, at least about 400 mg-N/L, or at least about 500 mg-N/L after calcium hydroxide is added to control alkalinity during PAD treatment as disclosed herein. In some embodiments, after calcium hydroxide is added to control alkalinity during PAD treatment as disclosed herein, 80% TIN to about 100% TIN, about 85% TIN to about 99% TIN, or about 90% to about 98% TIN may be removed from PAD influent. In some embodiments, after calcium hydroxide is added to control alkalinity during PAD treatment as disclosed herein, 80% TIN, about 85% TIN, about 90% TIN, about 95% TIN, about 96% TIN, about 97% TIN, about 98% TIN, about 99% TIN, or about 100% TIN may be removed from PAD influent.

In some embodiments, TN of PAD effluent may be at least about 0 mg-N/L to at least about 500 mg-N/L after PAD treatment as disclosed herein. In some other aspects, TN of digested sludge may be at least about 0 mg-N/L, at least about 50 mg-N/L, at least about 100 mg-N/L, at least about 150 mg-N/L, at least about 200 mg-NIL, at least about 250 mg-N/L, at least about 300 mg-N/L, at least about 400 mg-N/L, or at least about 500 mg-N/L after PAD treatment as disclosed herein. In some embodiments, PAD treatment as disclosed herein removes about 80% TN to about 100% TN, about 85% TN to about 99% TN, or about 90% TN to about 98% TN from PAD influent. In some embodiments, PAD treatment as disclosed herein removed about 80% TN, about 85% TN, about 90% TN, about 95% TN, about 96% TN, about 97% TN, about 98% TN, about 99% TN, or about 100% TN from PAD influent.

In some embodiments, TN of PAD effluent may be at least about 0 mg-N/L to at least about 500 mg-N/L after at least one calcium alkali is added to control alkalinity during PAD treatment as disclosed herein. In some other aspects, TN of digested sludge may be at least about 0 mg-N/L, at least about 50 mg-N/L, at least about 100 mg-N/L, at least about 150 mg-N/L, at least about 200 mg-N/L, at least about 250 mg-N/L, at least about 300 mg-N/L, at least about 400 mg-N/L, or at least about 500 mg-N/L after at least one calcium alkali is added to control alkalinity during PAD treatment as disclosed herein. In some embodiments, after at least one calcium alkali is added to control alkalinity during PAD treatment as disclosed herein, 80% TN to about 100% TIN, about 85% TN to about 99% TN, or about 90% to about 98% TN may be removed from PAD influent. In some embodiments, after at least one calcium alkali is added to control alkalinity during PAD treatment as disclosed herein, 80% TN, about 85% TN, about 90% TN, about 95% TN, about 96% TN, about 97% TN, about 98% TN, about 99% TN, or about 100% TN may be removed from PAD influent.

In some embodiments, TN of PAD effluent may be at least about 0 mg-N/L to at least about 500 mg-N/L after calcium hydroxide is added to control alkalinity during PAD treatment as disclosed herein. In some other aspects, TN of digested sludge may be at least about 0 mg-N/L, at least about 50 mg-N/L, at least about 100 mg-N/L, at least about 150 mg-N/L, at least about 200 mg-N/L, at least about 250 mg-N/L, at least about 300 mg-N/L, at least about 400 mg-N/L, or at least about 500 mg-N/L after calcium hydroxide is added to control alkalinity during PAD treatment as disclosed herein. In some embodiments, after calcium hydroxide is added to control alkalinity during PAD treatment as disclosed herein, 80% TN to about 100% TN, about 85% TN to about 99% TN, or about 90% to about 98% TN may be removed from PAD influent. In some embodiments, after calcium hydroxide is added to control alkalinity during PAD treatment as disclosed herein, 80% TN, about 85% TN, about 90% TN, about 95% TN, about 96% TN, about 97% TN, about 98% TN, about 99% TN, or about 100% TN may be removed from PAD influent.

In some aspects, PAD effluent may contain at least about 0 mg-N/L ammonia to at least about 500 mg-N/L ammonia after PAD treatment as disclosed herein. In some embodiments, PAD treatment as disclosed herein removes about 80% ammonia to about 100% ammonia, about 85% ammonia to about 99% ammonia, or about 90% ammonia to about 98% ammonia from PAD influent. In some embodiments, PAD treatment as disclosed herein removes about 80% ammonia, about 85% ammonia, about 90% ammonia, about 95% ammonia, about 96% ammonia, about 97% ammonia, about 98% ammonia, about 99% ammonia, or about 100% ammonia from PAD influent.

In some aspects, PAD effluent may contain at least about 0 mg-N/L ammonia to at least about 500 mg-N/L ammonia after addition of at least one calcium alkali to PAD treatment as disclosed herein. In some embodiments, addition of at least one calcium alkali to PAD treatment as disclosed herein removes about 80% ammonia to about 100% ammonia, about 85% ammonia to about 99% ammonia, or about 90% ammonia to about 98% ammonia from PAD influent. In some embodiments, addition of at least one calcium alkali to PAD treatment as disclosed herein removes about 80% ammonia, about 85% ammonia, about 90% ammonia, about 95% ammonia, about 96% ammonia, about 97% ammonia, about 98% ammonia, about 99% ammonia, or about 100% ammonia from PAD influent.

In some aspects, PAD effluent may contain at least about 0 mg-N/L ammonia to at least about 500 mg-N/L ammonia after addition of calcium hydroxide to PAD treatment as disclosed herein. In some embodiments, addition of calcium hydroxide to PAD treatment as disclosed herein removes about 80% ammonia to about 100% ammonia, about 85% ammonia to about 99% ammonia, or about 90% ammonia to about 98% ammonia from PAD influent. In some embodiments, addition calcium hydroxide to PAD treatment as disclosed herein removes about 80% ammonia, about 85% ammonia, about 90% ammonia, about 95% ammonia, about 96% ammonia, about 97% ammonia, about 98% ammonia, about 99% ammonia, or about 100% ammonia from PAD influent.

In some aspects, PAD effluent may contain at least about 0 mg-N/L nitrate to at least about 500 mg-N/L nitrate after PAD treatment as disclosed herein. In some embodiments, PAD treatment as disclosed herein removes about 80% nitrate to about 100% nitrate, about 85% nitrate to about 99% nitrate, or about 90% nitrate to about 98% nitrate from PAD influent. In some embodiments, PAD treatment as disclosed herein removed about 80% nitrate, about 85% nitrate, about 90% nitrate, about 95% nitrate, about 96% nitrate, about 97% nitrate, about 98% nitrate, about 99% nitrate, or about 100% nitrate from PAD influent.

In some aspects, PAD effluent may contain at least about 0 mg-N/L nitrate to at least about 500 mg-N/L nitrate after addition of at least one calcium alkali to PAD treatment as disclosed herein. In some embodiments, addition of at least one calcium alkali to PAD treatment as disclosed herein removes about 80% nitrate to about 100% nitrate, about 85% nitrate to about 99% nitrate, or about 90% nitrate to about 98% nitrate from PAD influent. In some embodiments, addition of at least one calcium alkali to PAD treatment as disclosed herein removed about 80% nitrate, about 85% nitrate, about 90% nitrate, about 95% nitrate, about 96% nitrate, about 97% nitrate, about 98% nitrate, about 99% nitrate, or about 100% nitrate from PAD influent.

In some aspects, PAD effluent may contain at least about 0 mg-N/L nitrate to at least about 500 mg-N/L nitrate after addition of calcium hydroxide to PAD treatment as disclosed herein. In some embodiments, addition of calcium hydroxide to PAD treatment as disclosed herein removes about 80% nitrate to about 100% nitrate, about 85% nitrate to about 99% nitrate, or about 90% nitrate to about 98% nitrate from PAD influent. In some embodiments, addition of calcium hydroxide to PAD treatment as disclosed herein removed about 80% nitrate, about 85% nitrate, about 90% nitrate, about 95% nitrate, about 96% nitrate, about 97% nitrate, about 98% nitrate, about 99% nitrate, or about 100% nitrate from PAD influent.

In some embodiments disclosed herein, phosphorous contained in PAD effluent after PAD treatment can be inorganic, organic, or a combination thereof. In other aspects, phosphorous contained in PAD effluent can be soluble. In still other aspects, phosphorous contained in PAD effluent can be phosphates. In some aspects, phosphates contained in PAD effluent can be orthophosphates, condensed phosphates, organic phosphates or a combination thereof.

In some embodiments, TP of PAD effluent after PAD treatment as disclosed herein may be at least about 40,000 μg/g to at least about 55,000 μg/g. In some other aspects, of PAD effluent after PAD treatment as disclosed herein may be at least about at least about 40,000 μg/g, at least about 45,000 μg/g, at least about 50,000 μg/g, or at least about 55,000 μg/g. In some embodiments, PAD treatment as disclosed herein removes at least about 50% TP to at least about 100% TP, at least about 60% TP to at least about 99% TP, or at least about 70% TP to at least about 98% TP from PAD influent. In some embodiments, PAD treatment as disclosed herein removes at least about 50% TP, at least about 60% TP, at least about 70% TP, at least about 80% TP, at least about 85% TP, at least about 90% TP, at least about 95% TP, at least about 99% TP, or at least about 100% TP from PAD influent.

In other aspects, soluble phosphorous contained in PAD effluent after PAD treatment as disclosed herein can be orthophosphate. In some aspects, orthophosphate of PAD effluent after PAD treatment as disclosed herein may be at least about 0 mg-P/L to at least about 150 mg-P/L. In some other aspects, orthophosphate of PAD effluent after PAD treatment as disclosed herein may be at least about 0 mg-P/L, at least about 25 mg-P/L, at least about 50 mg-P/L, at least about 75 mg-P/L, at least about 100 mg-P/L or at least about 150 mg-P/L. In some embodiments, PAD treatment as disclosed herein removes about 200 mg-P/L orthophosphate to about 500 mg-P/L orthophosphate from PAD influent. In some embodiments, PAD treatment as disclosed herein removes about 200 mg-P/L, about 250 mg-P/L, about 300 mg-P/L, about 350 mg-P/L, about 400 mg-P/L, about 450 mg-P/L, or about 500 mg-P/L orthophosphate from PAD influent. In some embodiments, PAD treatment as disclosed herein removes at least about 50% orthophosphate to at least about 100% orthophosphate, at least about 60% orthophosphate to at least about 99% orthophosphate, or at least about 70% orthophosphate to at least about 98% orthophosphate from PAD influent. In some embodiments, PAD treatment as disclosed herein removes at least about 50% orthophosphate, at least about 60% orthophosphate, at least about 70% orthophosphate, at least about 80% orthophosphate, at least about 85% orthophosphate, at least about 90% orthophosphate, at least about 95% orthophosphate, at least about 99% orthophosphate, or at least about 100% orthophosphate from PAD influent.

In some embodiments, orthophosphate of PAD effluent after addition of at least one calcium alkali to the PAD treatment as disclosed herein may be at least about 0 mg-P/L to at least about 150 mg-P/L. In some other aspects, orthophosphate of PAD effluent after addition of at least one calcium alkali to the PAD treatment as disclosed herein may be at least about 0 mg-P/L, at least about 25 mg-P/L, at least about 50 mg-P/L, at least about 75 mg-P/L, at least about 100 mg-P/L or at least about 150 mg-P/L. In some embodiments, PAD treatment in the presence of at least one calcium alkali as disclosed herein can remove about 200 mg-P/L orthophosphate to about 500 mg-P/L orthophosphate from PAD influent. In some embodiments, PAD treatment in the presence of at least one calcium alkali as disclosed herein can remove about 200 mg-P/L, about 250 mg-P/L, about 300 mg-P/L, about 350 mg-P/L, about 400 mg-P/L, about 450 mg-P/L, or about 500 mg-P/L orthophosphate from PAD influent. In some embodiments, PAD treatment in the presence of at least one calcium alkali as disclosed herein can remove at least about 50% to at least about 100% o, at least about 65% to at least about 99%, or at least about 80% to at least about 98% more orthophosphate from PAD influent compared to the amount of orthophosphate removed by PAD treatment in the absence of at least one calcium alkali as disclosed herein. In some embodiments, PAD treatment in the presence of at least one calcium alkali as disclosed herein can remove at least about 50%, at least about 60%, at least about 70%, at least about 80%, at least about 85%, at least about 90%, at least about 95%, at least about 99%, or at least about 100% more orthophosphate from PAD influent compared to compared to the amount of orthophosphate removed by PAD treatment in the absence of at least one calcium alkali as disclosed herein.

In some embodiments, orthophosphate of PAD effluent after addition of calcium hydroxide to the PAD treatment as disclosed herein may be at least about 0 mg-P/L to at least about 150 mg-P/L. In some other aspects, orthophosphate of PAD effluent after addition of calcium hydroxide to the PAD treatment as disclosed herein may be at least about 0 mg-P/L, at least about 25 mg-P/L, at least about 50 mg-P/L, at least about 75 mg-P/L, at least about 100 mg-P/L or at least about 150 mg-P/L. In some embodiments, PAD treatment in the presence of calcium hydroxide as disclosed herein can remove about 200 mg-P/L orthophosphate to about 500 mg-P/L orthophosphate from PAD influent. In some embodiments, PAD treatment in the presence of calcium hydroxide as disclosed herein can remove about 200 mg-P/L, about 250 mg-P/L, about 300 mg-P/L, about 350 mg-P/L, about 400 mg-P/L, about 450 mg-P/L, or about 500 mg-P/L orthophosphate from PAD influent. In some embodiments, PAD treatment in the presence of calcium hydroxide as disclosed herein can remove at least about 50% to at least about 100%, at least about 65% to at least about 99%, or at least about 80% to at least about 98% more orthophosphate from PAD influent compared to the amount of orthophosphate removed by PAD treatment in the absence of calcium hydroxide as disclosed herein. In some embodiments, PAD treatment in the presence of calcium hydroxide as disclosed herein can remove at least about 50%, at least about 60%, at least about 70%, at least about 80%, at least about 85%, at least about 90%, at least about 95%, at least about 99%, or at least about 100% more orthophosphate from PAD influent compared to compared to the amount of orthophosphate removed by PAD treatment in the absence of calcium hydroxide as disclosed herein.

In some embodiments, addition of at least one calcium alkali to the PAD treatment as disclosed herein may remove phosphate from PAD effluent through precipitation of calcium phosphate. In some aspects, precipitated calcium phosphate may be brushite, hydroxyapatite, or a combination thereof. In some other aspects, precipitated calcium phosphate may be brushite.

In some embodiments, addition of calcium hydroxide to the PAD treatment as disclosed herein may remove phosphate from PAD effluent through precipitation of calcium phosphate. In some aspects, precipitated calcium phosphate may be brushite, hydroxyapatite, or a combination thereof. In some other aspects, precipitated calcium phosphate may be brushite.

In some embodiments, centrate may be removed after PAD treatment as disclosed herein and recycled back to the primary tank. As used herein, the term “centrate” refers to the liquid removed from a thickened sludge, such as PAD effluent. In some aspects, centrate removed after PAD treatment as disclosed can encompass about 50 mg-P/L orthophosphates to about 150 mg-P/L orthophosphates. In some other aspects, centrate removed after PAD treatment as disclosed herein can encompass about 50 mg-P/L, about 75 mg-P/L, about 100 mg-P/L, about 125 mg-P/L, or about 150 mg-P/L orthophosphates.

In some embodiments, a PAD treatment disclosed herein can reduce foam generated in a PAD reactor. In some aspects, foam generated in a PAD reactor before adding alkalinity during PAD treatment as disclosed herein may be about 0.3 feet to about 1.0 feet thick, about 0.4 feet to about 0.9 feet thick, or about 0.5 to about 0.8 feet thick. In some other aspects, foam generated in a PAD reactor before adding alkalinity during PAD treatment as disclosed herein may be about 0.3 feet thick, about 0.4 feet thick, about 0.5 feet thick, about 0.6 feet thick, about 0.7 feet thick, about 0.9 feet thick, or about 1.0 feet thick. In some aspects, foam generated in a PAD reactor after adding alkalinity during PAD treatment as disclosed herein may be about 0.0 feet to about 0.3 feet thick, about 0.05 feet to about 0.25 feet thick, or about 0.1 to about 0.2 feet thick. In some other aspects, foam generated in a PAD reactor after adding alkalinity during PAD treatment as disclosed herein may be about 0.0 feet thick, about 0.05 feet thick, about 0.1 feet thick, about 0.15 feet thick, about 0.2 feet thick, about 0.25 feet thick, or about 0.3 feet thick. In some aspects, foam generated in a PAD reactor after adding at least one calcium alkali during PAD treatment as disclosed herein may be about 0.0 feet to about 0.3 feet thick, about 0.05 feet to about 0.25 feet thick, or about 0.1 to about 0.2 feet thick. In some other aspects, foam generated in a PAD reactor after adding at least one calcium alkali during PAD treatment as disclosed herein may be about 0.0 feet thick, about 0.05 feet thick, about 0.1 feet thick, about 0.15 feet thick, about 0.2 feet thick, about 0.25 feet thick, or about 0.3 feet thick. In still some other aspects, foam generated in a PAD reactor after adding calcium hydroxide during PAD treatment as disclosed herein may be about 0.0 feet to about 0.3 feet thick, about 0.05 feet to about 0.25 feet thick, or about 0.1 to about 0.2 feet thick. In yet some other aspects, foam generated in a PAD reactor after adding calcium hydroxide during PAD treatment as disclosed herein may be about 0.0 feet thick, about 0.05 feet thick, about 0.1 feet thick, about 0.15 feet thick, about 0.2 feet thick, about 0.25 feet thick, or about 0.3 feet thick.

In some embodiments, reduced foam generated in a PAD reactor after adding at least one calcium alkali during PAD treatment as disclosed herein may increase operating volume in the PAD reactor tank compared to the operating volume in a PAD actor tank wherein a PAD process as disclosed herein was performed in the absence of at least one calcium alkali. In some aspects, operating volume may be increased by at least about 10% to at least about 99%, at least about 20% to at least about 80%, or at least about 30% to about 70%. In some embodiments, reduced foam generated in a PAD reactor after adding at calcium hydroxide during PAD treatment as disclosed herein may increase operating volume in the PAD reactor tank compared to the operating volume in a PAD actor tank wherein a PAD process as disclosed herein was performed in the absence of calcium hydroxide. In some aspects, operating volume may be increased by at least about 10% to at least about 99%, at least about 20% to at least about 80%, or at least about 30% to about 70%.

In some embodiments, application of a PAD treatment process as disclosed herein may reduce the need for at least one tertiary treatment. As used herein, the term “tertiary treatment” refers to additional processes for filtering the liquid effluent from a secondary wastewater treatment system, such as after PAD treatment. Tertiary sewage treatment can provide for additional removal of suspended solids from the secondary effluent and a further reduction of the biochemical oxygen demand (BOD). A non-limiting example of a standard method of tertiary treatment is a tertiary filter system that provides filter cell flow division, filtration, air scouring, backwashing, and backwash return of the wastewater. In some aspects, addition of at least one calcium alkali to a PAD treatment process as disclosed herein may reduce the need for at least one tertiary treatment. In some other aspects, addition of calcium hydroxide to a PAD treatment process as disclosed herein may reduce the need for at least one tertiary treatment. In still some other aspects, addition of at least one calcium alkali to a PAD treatment process as disclosed herein may reduce the need for at least on chemical addition at a tertiary filter. In some other aspects, addition of calcium hydroxide to a PAD treatment process as disclosed herein may reduce the need for at least on chemical addition at a tertiary filter.

In some embodiments, application of a PAD treatment process as disclosed herein may improve at least one downstream process. As used herein, the term “downstream process” refers to any additional processing method of the PAD effluent into a final product. Non-limiting examples of downstream processes include dewatering, conditioning, drying, centrate return, and biological nutrient removal (BNR) process. In some aspects, PAD treatment in the presence of at least one calcium alkali as disclosed herein can increase dewatered total solids concentration compared to PAD treatment in the absence of at least one calcium alkali. In some other aspects, PAD treatment in the presence of calcium hydroxide as disclosed herein can increase dewatered total solids concentration compared to PAD treatment in the absence of calcium hydroxide. In some aspects, PAD treatment in the presence of at least one calcium alkali as disclosed herein can decrease the need for polymer addition during dewatering compared to PAD treatment in the absence of at least one calcium alkali. In some other aspects, PAD treatment in the presence of calcium hydroxide as disclosed herein can decrease the need for polymer addition during dewatering compared to PAD treatment in the absence of calcium hydroxide. In some aspects, PAD treatment in the presence of at least one calcium alkali as disclosed herein can reduce the likelihood of nuisance struvite production thereby protecting the pipes and infrastructure against scale compared to PAD treatment in the absence of at least one calcium alkali. In some other aspects, PAD treatment in the presence of calcium hydroxide as disclosed herein can reduce the likelihood of nuisance struvite production thereby protecting the pipes and infrastructure against scale compared to PAD treatment in the absence of calcium hydroxide. In some aspects, PAD treatment in the presence of at least one calcium alkali as disclosed herein can reduce the need for supplemental carbon addition during BNR compared to PAD treatment in the absence of at least one calcium alkali. In some other aspects, PAD treatment in the presence of calcium hydroxide as disclosed herein can reduce the need for supplemental carbon addition during BNR compared to PAD treatment in the absence of calcium hydroxide. In some aspects, PAD treatment in the presence of at least one calcium alkali as disclosed herein can reduce odor compared to PAD treatment in the absence of at least one calcium alkali. In some other aspects, PAD treatment in the presence of calcium hydroxide as disclosed herein can odor compared to PAD treatment in the absence of calcium hydroxide.

In some embodiments, use of PAD treatments as disclosed herein can reduce nitrogen, phosphorus, or a combination thereof recycled back to a liquid stream. In some aspects, use of PAD treatments as disclosed herein can reduce nitrogen and phosphorus recycled back to a liquid stream.

In some embodiments, use of PAD treatments encompassing at least one calcium alkali as disclosed herein can reduce nitrogen and phosphorus recycled back to a liquid stream compared to PAD treatments that do not encompass at least one calcium alkali. In some aspects, use of PAD treatments encompassing at least one calcium alkali as disclosed herein can reduce at least about 10% to at least about 90%, at least about 20% to at least about 80%, or at least about 30% to at least about 70% of the amount of nitrogen and phosphorus recycled back to a liquid stream compared to PAD treatments that do not encompass at least one calcium alkali.

In some embodiments, use of PAD treatments encompassing calcium hydroxide as disclosed herein can reduce nitrogen and phosphorus recycled back to a liquid stream compared to PAD treatments that do not encompass calcium hydroxide. In some aspects, use of PAD treatments encompassing calcium hydroxide as disclosed herein can reduce at least about 10% to at least about 90%, at least about 20% to at least about 80%, or at least about 30% to at least about 70% of the amount of nitrogen and phosphorus recycled back to a liquid stream compared to PAD treatments that do not encompass calcium hydroxide.

In some embodiments, use of PAD treatments as disclosed herein yield nitrogen- and phosphorus-rich biosolids. As used herein, the term “biosolids” refers to the nutrient-rich organic materials resulting from the final treatment of domestic sewage. In some aspects, use of PAD treatments as disclosed herein yield nitrogen- and phosphorus-rich biosolids for use as fertilizer. The high level of nitrogen and phosphorous can improve and maintain productive soils and stimulate plant growth. In some embodiments, use of PAD treatments encompassing at least one calcium alkali as disclosed herein can produce biosolids containing more nitrogen, phosphorus, or a combination thereof compared to biosolids produced using PAD treatments that do not encompass at least one calcium alkali. In some aspects, use of PAD treatments encompassing at least one calcium alkali as disclosed herein can produce biosolids containing more nitrogen and phosphorus compared to biosolids produced using PAD treatments that do not encompass at least one calcium alkali. In some embodiments, use of PAD treatments encompassing calcium hydroxide as disclosed herein can produce biosolids containing more nitrogen, phosphorus, or a combination thereof compared to biosolids produced using PAD treatments that do not encompass calcium hydroxide. In some aspects, use of PAD treatments encompassing at calcium hydroxide as disclosed herein can produce biosolids containing more nitrogen and phosphorus compared to biosolids produced using PAD treatments that do not encompass calcium hydroxide.

In some embodiments, use of PAD treatments as disclosed herein allow for improved recycling of phosphorous from wastewater. In some embodiments, use of PAD treatments encompassing at least one calcium alkali as disclosed herein allow for improved recycling of phosphorous from wastewater compared to PAD treatments that do not encompass at least one calcium alkali. In some aspects, addition of at least one calcium alkali to PAD treatments as disclosed herein can precipitate calcium and/or phosphate from PAD effluent for phosphate recycling. In some other aspects, addition of at least one calcium alkali to PAD treatments as disclosed herein can precipitate one or more calcium phosphate compounds from PAD effluent for phosphate recycling. Non-limiting examples of calcium phosphate compound precipitates that can be extracted from the final product to recycle phosphorous include octacalcium phosphate (Ca₈(HPO₄)₂(PO₄)₄.5H₂O)), amorphous calcium phosphate (Ca₃(PO₄)₂.xH₂O), monetite (CaHPO₄), whitlockite (Ca₉(MgFe)(PO₄)₆PO₃OH), tricalcium phosphate (Ca₃(PO₄)₂), brushite (CaHPO₄.2H₂O), and hydroxyapatite (Ca₅(PO₄)₃(OH)). In some other aspects, addition of calcium hydroxide to PAD treatments as disclosed herein can precipitate calcium phosphate from PAD effluent for phosphate recycling. In some aspects, addition of at least one calcium alkali to PAD treatments disclosed herein can precipitate calcium phosphate from PAD effluent to be used as a separate end product than biosolids. In some other aspects, addition of calcium hydroxide to PAD treatments as disclosed herein can precipitate calcium phosphate from PAD effluent to be used as a separate end product than biosolids.

While several inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

All definitions, as defined and used herein, should be understood to control over dictionary definitions, definitions in documents incorporated by reference, and/or ordinary meanings of the defined terms.

All references, patents and patent applications disclosed herein are incorporated by reference with respect to the subject matter for which each is cited, which in some cases may encompass the entirety of the document.

The indefinite articles “a” and “an,” as used herein in the specification and in the claims, unless clearly indicated to the contrary, should be understood to mean “at least one.” The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

It should also be understood that, unless clearly indicated to the contrary, in any methods claimed herein that include more than one step or act, the order of the steps or acts of the method is not necessarily limited to the order in which the steps or acts of the method are recited.

### Examples

The following examples are included to demonstrate various embodiments of the present disclosure. It should be appreciated by those of skill in the art that the techniques disclosed in the examples that follow represent techniques discovered by the inventors to function well in the practice of the invention, and thus can be considered to constitute preferred modes for its practice. However, those of skill in the art should, in light of the present disclosure, appreciate that many changes can be made in the specific embodiments which are disclosed and still obtain a like or similar result without departing from the spirit and scope of the invention.

EXAMPLE 1. The post aerobic digestion (PAD) reactor, shown in FIG. 1, was used to treat the effluent solids flow from the anaerobic digester. In brief, effluent solids from the anaerobic digester were sent to the PAD reactor, where cyclic aeration at low dissolved oxygen resulted in both nitrification with ammonium oxidizing bacteria (AOB) and denitrification with heterotrophic bacteria. Denitrification was driven by the oxidation of slowly oxidized compounds as well as the degradation of products previously identified as unbiodegradable.

Nitrogen removal was consistently achieved throughout operation; however, nitrification was limited by the availability of alkalinity in the PAD reactor. While alkalinity is produced in the anaerobic digesters, the alkalinity was decreased by addition of ferric chloride to the anaerobic digesters to manage biogas hydrogen sulfide concentrations. During operational periods where alkalinity limits nitrification in the PAD reactor (through both bicarbonate limitation and pH dropping below 6.0), 69% of the PAD influent ammonium is nitrified compared to 95% nitrification of the influent ammonium when the process is not alkalinity limited.

The system used for PAD included two storage tanks each with a capacity of 1,650 gallons, for a total storage capacity of 3,300 gallons. The post-digestion sludge storage tank had equipment added for continuous and cyclic aeration during the PAD process. Due to the storage tank aeration configuration, a continuous, low-level aeration was not successful because the levels of dissolved oxygen were not low enough to allow for the microorganisms to achieve simultaneous nitrification (ammonia oxidation to nitrite or nitrate) and denitrification (nitrite or nitrate reduction to nitrogen gas).

To balance the loss of alkalinity during nitrification with the gain of alkalinity during denitrification, the cyclic aeration schedule was adjusted to create alternating aerated and un-aerated conditions during PAD. This operating condition for PAD was intended to remove nitrogen return loads by cyclically driving nitritation and denitritation with ammonium oxidizing bacteria (AOB) and heterotrophic bacteria, respectively. The carbon necessary for denitritation was expected to be provided by the oxidation of slowly oxidized compounds as well as the degradation of products previously identified as unbiodegradable (Friedrich et al., WATER ENVIRONMENT RESEARCH. 2016, 88(3):272-279, the disclosures of which are incorporated herein). Ideally, this denitritation process could help recover alkalinity for pH buffering and prevent inorganic carbon limitations for AOB.

For aerated/unaerated cycles, the aeration was on a timer (90 minutes) followed by air off (30 minutes) at an air rate that generated dissolved oxygen concentration in the 1-2 mg/L range. These times and aeration rates vary based on process conditions. The aeration times tested were based on reducing the effluent ammonia concentration to 100 mg/L or less, and the unaerated times were based on reducing the nitrate below about 50 mg/L while also regaining some “free” alkalinity that is generated by denitrification. In the full-scale operational case, the PAD process showed that adjustments to cycle times for aeration were insufficient to balance nitritation kinetics with alkalinity requirements (FIG. 3 at Aug. 14, 2017 to Oct. 2, 2017).

The next step in PAD optimization was to increase alkalinity during the PAD process, chemical and carbon source(s) were added to the PAD system according to the design criteria and site specific deviations described in Table 1.

TABLE 1
Design Criteria

| | |
|---|---|
| Design Criteria | Compliance to Design Criteria |

A. The design must consider the following for treatment chemical selection:

| | | |
|---|---|---|
| 1. | Compatibility with other chemicals being | Confirmed, no issues expected with |
| | used. | chemicals used. |
| 2. | Compatibility with other liquids, solids, and | Lime is compatible with the |
| | air treatment processes (e.g., interference). | downstream treatment processes. |
| | | No interferences were anticipated. |
| 3. | Provisions for avoiding adverse impacts to | Overdosing of lime could lead to |
| | effluent, receiving waters, biosolids, or air | adverse impacts on dewatering |
| | quality (e.g., interference, inhibition, pass | performance; however, these |
| | through, accumulation in biosolids). | impacts did not affect biosolids |
| | | quality. |
| 4. | Calculated appropriate design dosage | This was been done successfully |
| | ranges, including laboratory tests (jar tests | during the study. |
| | or pilot-scale studies) on actual process | |
| | wastewater or operational data from similar | |
| | facilities. | |

B. Chemical storage design must provide adequate storage capacity as well as
efficient and safe chemical handing. Important factors in determining storage
capacity include reliability of the supply, quantity of shipment, the range of
chemical use rates, and chemical decomposition during storage. Specifically,
the chemical storage design must consider:

| | | |
|---|---|---|
| 1. | Sufficient chemical storage for design | Yes. |
| | application. | |
| 2. | Compatibility with the chemical type and | No compatibility issues with the |
| | form (dry, liquid, or gas). | chemical type and form were |
| | | expected. |
| 3. | Temperature and moisture controls. | No temperature and moisture |
| | | issues were expected inside the |
| | | climate-controlled building. |
| 4. | Safe and easy operator access. | The tanks and dosing pumps were |
| | | configured to allow for proper |
| | | access for operations and |
| | | maintenance activities. |
| 5. | Dust control. | Not required for a hydrated lime |
| | | chemical. |
| 6. | Containers stored in manner to allow floor | Yes. |
| | level cleanup. | |
| 7. | High and low level indicators in tanks and | Levels were manually recorded |
| | bins. | each shift by the operators. |
| | | Because the chemical was not |
| | | critical, online level indication is not |
| | | necessary. |
| 8. | Provisions for continuous feed, if used, | Provisions for continuous feed were |
| | including angle of repose and vibrators. | provided, including top-mounted |
| | | mixers. |
| 9. | Spill and overflow containment with | Spill containment provided with the |
| | sufficient volume to hold the contents of the | building drain system that returns |
| | largest tank in the containment area. Ability | any spills to the Headworks. This |
| | to access drain valves safely without | was not a critical process and spills |
| | entering containment area.* | can be diluted with process water |
| | | and returned to the Headworks for |
| | | complete treatment with no adverse |
| | | effect to the secondary treatment |
| | | process. |
| 10. | Leak-detection indicator and alarm for | Leak detection was made using |
| | hazardous chemicals. | visual verification. No |
| | | instrumentation is needed. |
| 11. | Adequate connections and equipment for | The delivery piping was configured |
| | washing, flushing, and cleanout in chemical | to allow for easy flushing of the |
| | storage areas. | chemical lines. |
| 12. | Pressure/vacuum relief on enclosed tanks. | Not applicable. Tanks were not fully |
| | | enclosed. |
| 13. | For hazardous chemicals, appropriate | The existing facility included safety |
| | safety provisions such as eyewash stations, | provisions. |
| | emergency showers, and emergency | |
| | communication documents. | |

C. Chemical Handling Design

| | | |
|---|---|---|
| 1. | The design must provide for safe and | The design accounted for these |
| | efficient unloading, storage, transfer, and | criteria. |
| | use of chemicals in accordance with | |
| | appropriate codes considering types of | |
| | chemicals, compatibility, and the amount of | |
| | handling required. | |
| 2. | The liquid chemical storage tank and tank | Spill containment provided with the |
| | fill connections shall be located within a | building drain system that returns |
| | containment structure. Valves on | any spills to the Headworks. This |
| | discharge lines shall be located adjacent to | was not a critical process and spills |
| | the storage tank and within the containment | can be diluted with process water |
| | structure. Auxiliary facilities, including | and returned to the Headworks for |
| | pumps and controls, within the containment | complete treatment with no adverse |
| | area shall be located above the highest | effect to the secondary treatment |
| | anticipated liquid level. Containment areas | process. |
| | shall be sloped to a sump area and shall not | |
| | contain floor drains.* | |
| 3. | Platforms, stairs, and railings shall be | Not applicable. |
| | provided as necessary, to afford convenient | |
| | and safe access to all filling connections, | |
| | storage tank entries, and measuring | |
| | devices. Storage tanks shall have | |
| | reasonable access provided to facilitate | |
| | cleaning. | |
| 4. | Above-bottom drawoff from chemical | Included in the system. |
| | storage or feed tanks shall be provided as | |
| | necessary to avoid withdrawal of settled | |
| | solids into the feed system. Provisions for | |
| | periodic removal of accumulated settled | |
| | solids must be included. Provisions must | |
| | be made in the fill lines to prevent back | |
| | siphonage of chemical tank contents. | |
| 5. | All liquid chemical mixing and feed | Pumps were placed on a pedestal |
| | installations must be installed on corrosion | to comply with this criterion. Mixers |
| | resistant pedestals and elevated above the | were in compliance. |
| | highest liquid level anticipated during | |
| | emergency conditions. The chemical feed | |
| | equipment shall be designed to meet the | |
| | maximum dosage requirements for the | |
| | design conditions. | |
| 6. | The design must include equipment to | Tank level variations and pump |
| | measure quantities of chemicals fed from | speed were used to measure |
| | bulk storage and day storage tanks over the | dosing rates. |
| | range of design application rates. | |
| 7. | Critical chemical feed equipment must have | This was not a critical chemical |
| | a backup system. Firm capacity shall meet | system. |
| | design requirements. | |

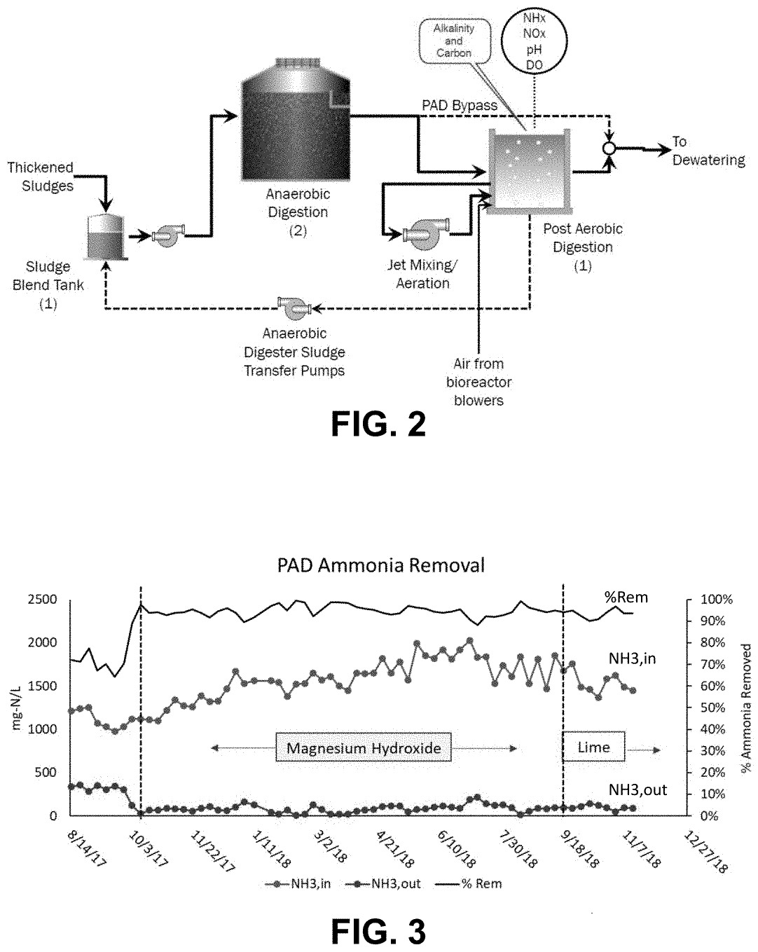

Chemical and carbon source(s) in compliance to design criteria were added to the PAD system several times per day, as needed. Chemical storage tanks and dosing pumps were used to feed the chemical(s) to the reactor. Specifically, a duty and a stand-by chemical dosing pump with a flow range of 0.09 to 0.98 gpm were used. Average dosing was approximately 137.5 gallons per day which equated to approximately 24 days of storage at current flows. The amount of chemical added was calculated to maintain sufficient calcium carbonate alkalinity in PAD effluent directly from the bag or using eductor/dispenser (FIG. 2). Sampling and analysis was performed as detailed in Table 2.

TABLE 2
Sampling and Analysis During PAD

| | Sample Locations | | | |
|---|---|---|---|---|
| | PAD | PAD | Sampling | Sampling |
| Parameter | Influent | Effluent | Frequency | Type |
| Alkalinity, mg/l as | X | X | Once a Day* | Grab Sample |
| CaCO₃ | | | | |
| Ammonia, mg/l | X | X | Once a | Grab Sample/On |
| | | | Day*/ | Line |
| | | | Continuous | Instrumentation |
| pH | X | X | Once a | Grab Sample/ On |
| | | | Day*/ | Line |
| | | | Continuous | Instrumentation |
| Nitrate, mg/l | X | X | Once a Day* | Grab Sample/On |
| | | | | Line |
| | | | | Instrumentation |
| Chemical Oxygen | X | X | 2-3 Times a | Grab Sample |
| Demand (COD) | | | Week | |

*During alkalinity addition days.

The pH level of PAD was monitored by the existing Distributed Control System (DCS). Briefly, as the pH drops, the pump speed was manually increased by Operations staff to provide additional alkalinity. Tank levels were visually inspected by Operations staff to ensure timely delivery of chemical. Other parameters were measured using standard procedures known in the art.

The first chemical evaluated was magnesium hydroxide. Continuous aeration was attempted during the evaluation; however, uncontrollable nitrite and nitrous acid toxicity led to the abandonment of continuous aeration. Cyclic aeration control was utilized over the course of alkalinity addition evaluation. As shown in FIG. 3, with the addition of magnesium hydroxide, AOB activity was no longer inhibited and substantially complete oxidation of ammonia was achieved. As illustrated in FIG. 3, the response to the addition of magnesium hydroxide was nearly immediate. Within two days, the ammonia concentrations dropped from approximately 300 mg-N/L to well within the effluent target range of 100 mg-N/L. From a pre-optimization total inorganic nitrogen (TIN) removal of 69% at an unstable average pH of 5.9, TIN was removed at a rate of 94% at a pH between 5.9-6.3 from April 2018 through the end of August 2018 with magnesium hydroxide.

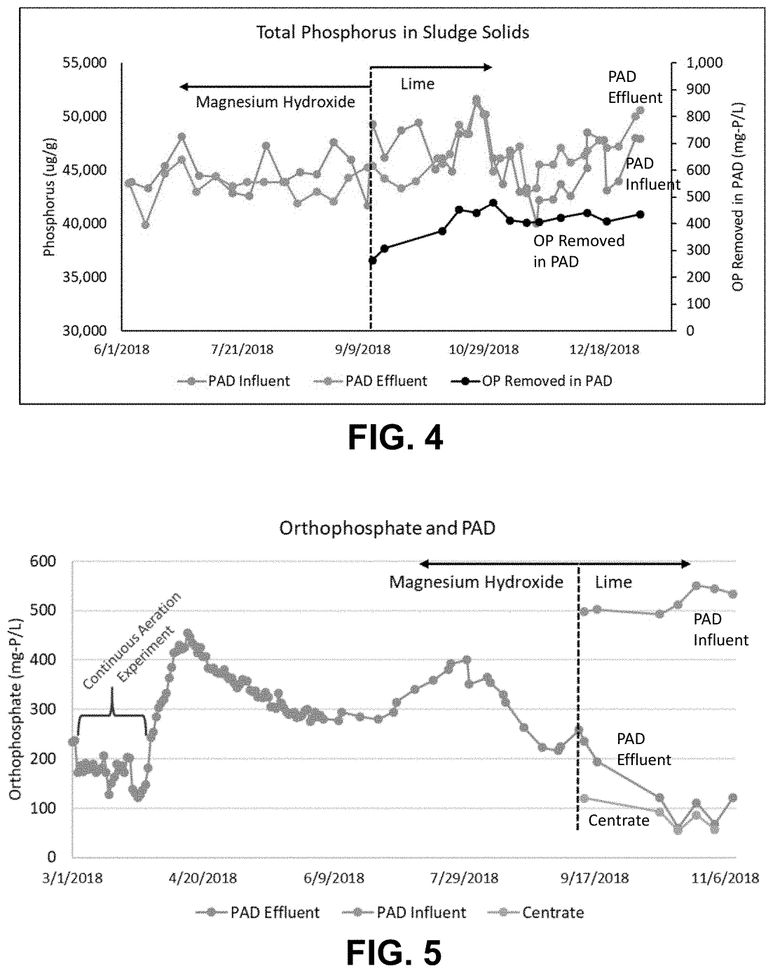

While the addition of magnesium hydroxide was effective at improving nitrogen elimination in PAD and thus the subsequent dewatering return stream nitrogen load, it did not have much impact on reducing the return phosphorus load. The current permitted total phosphorus effluent maximum concentration for the treatment plant was 1.0 mg/L on a running annual median. As shown in FIG. 4, the phosphate return concentration from PAD was still in the 300 mg-P/L range even after long-term operation with magnesium hydroxide addition. Additionally, the orthophosphate concentration in the centrate averaged 316 mg-P/L after long-term operation with magnesium hydroxide addition. Phosphorus release was prevalent across PAD, as indicated by the total phosphorus in the PAD effluent of 43,600 ug/g compared with 44,700 in the influent.

Struvite, or magnesium ammonium phosphate hexahydrate, (MgNH₄PO₄.6H₂O), is the primary species for magnesium and phosphorus precipitation, which occurs ideally at a pH greater than 7 (Daegi et al., ENVIRONMENTAL ENGINEERING RESEARCH. 2017, 22(1):12-18, the disclosures of which are incorporated herein). Although magnesium was supplied in excess of the pH required for maintaining nitrogen removal (5.9-6.3), the production of struvite was minimal.

Next, the addition of lime was investigated as a means of providing alkalinity to support a stable nitrification/denitrification process, while also promoting the sequestration of phosphorus through the formation of a calcium phosphate precipitant. After switching to lime addition in August of 2018, the phosphorus contained within the solids of the PAD effluent were been consistently equal to or slightly greater than the phosphorus contained within the PAD influent solids (47,500 ug/g on average compared to 47,100 ug/g, respectively). As shown in FIG. 3, no decrease in total inorganic nitrogen (TIN) removal was observed in the switch from magnesium hydroxide to calcium hydroxide.

Calcium and phosphorus can form precipitates at a variety of pH values, and it was likely that lime addition has enhanced phosphorus removal overall from the PAD reactor through the precipitation of calcium phosphates such as brushite and/or hydroxyapatite at the pH of 6.4 targeted under lime addition. Further, brushite and/or hydroxyapatite can form at the lower pH values at which the PAD is operated. X-ray diffraction (XRD) and scanning electron microscopy (SEM) monitors the presence of calcium phosphates, as well as a more robust phosphorus balance in the samples. In addition to reducing nitrogen and phosphorus recycled back to a liquid stream, an optimal PAD process would also precipitate brushite while adding alkalinity. The point where bicarbonate began to quickly reduce in availability for nitrification is at a pH level of 6.35. The availability of bicarbonate for nitrification was mostly unavailable a pH levels below 5.9. Brushite appeared to be the primary calcium phosphate precipitate when lime was added to maintain a below a pH of 6.9. Precipitation of brushite and not other calcium phosphate species was preferred because brushite did not cause scaling on pipes and pumps. Accordingly, chemical(s) were added to the PAD process to keep the pH above 6.3 and below 6.9. Specifically, calcium hydroxide was added to increase the pH to 6.5, and then when the pH level dropped back to 6.3, calcium hydroxide was added again. The pH would have to be optimized if there were any changes to the facility equipment or process.

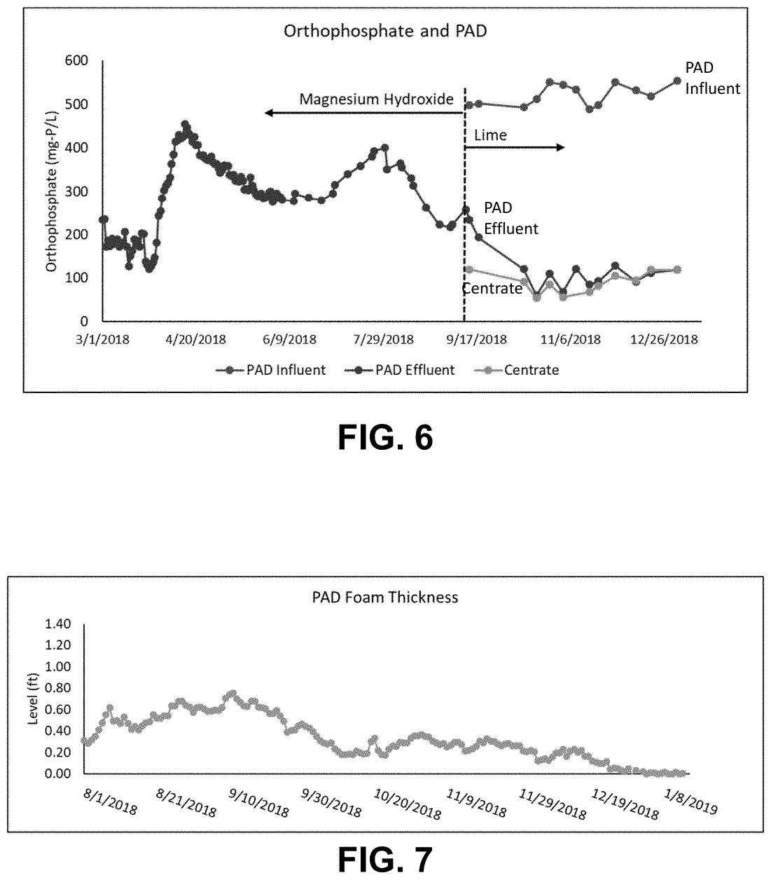

The observed increase in phosphorus in the biosolids (FIG. 4) also coincided with a decrease in orthophosphate concentrations within PAD (FIGS. 5 and 6). Also, the orthophosphate concentration was lower than the orthophosphate concentration was during a continuous aeration experiment that was run on PAD, which was aimed at simplifying operation. Orthophosphate concentrations in the centrate averaged 119 mg phosphate/L (FIGS. 5 and 6). While the continuous aeration experiment succeeded in reducing biological phosphorus release and effluent orthophosphate, runaway effluent nitrite (excess of 700 mg-N) held continuous aeration from succeeding. Lime addition surprisingly provided the dual benefit of stabilizing pH for cyclic nitrification/denitrification with minimal residual nitrite or nitrate, while also removing a high percentage (about 80% removal) of orthophosphate from the liquid stream.

An additional, unexpected benefit of lime addition was the reduction of foaming within the PAD tank. To combat the average 0.7-foot thick foam layer that forms during the PAD process, mixing pump bypass was previously required to spray down the foam to an acceptable thickness. Following lime addition, the foam layer decreased to less than 0.1 feet (FIG. 7), which increased the available operating volume in PAD and improved operational flexibility.

EXAMPLE 2. The PAD process is a sidestream nitrogen removal process, situated between anaerobic digestion and biosolids dewatering. Alkalinity addition not only optimized the PAD process, alkalinity addition also affects processes downstream of PAD.

Following PAD in the presence of magnesium or lime, the improved nitrogen elimination in PAD lowered the subsequent dewatering return stream nitrogen load (FIG. 2). As such, alkalinity addition in the PAD process impacted the dewatered total solids concentration as well as the polymer requirements. Alkalinity addition to PAD resulted in minimal struvite formation, even when chemicals are added in excess of the pH required for maintaining nitrogen removal (5.9-6.3). Accordingly, the reduced struvite production due to the alkalinity addition to PAD protects the pipes and infrastructure against scale. In addition, the calcium phosphate precipitates separated from the sludge after treatment produce a separate product. Both nitrogen and phosphorus concentrations were reduced in the centrate return following lime addition to PAD (FIGS. 2 and 3). The reduction of return nitrogen stabilizes the nitrogen removal process in the activated sludge system, resulting in improved biological nutrient removal (BNR) and lowered effluent nitrogen concentrations while also reducing chemical carbon addition. Further, the reduced phosphorus in the return centrate optimizes phosphorus removal of the BNR process and reduces reliance on chemical addition at the tertiary filters. As a result, alkalinity addition to PAD leads to odor reduction and reduced need for supplemental carbon addition.

A summary of the impact of alkalinity addition to the PAD process on downstream processes is summarized in Table 3.

TABLE 3
Impact of PAD Alkalinity Addition on Downstream Processes

| | Impact of PAD Alkalinity Addition on |
|---|---|
| Unit Process | Downstream Processes |
| Dewatering | Alkalinity addition in the PAD process impacts the |
| | dewatered total solids concentration as well as the |
| | polymer requirements. The dewatering process may |
| | require optimization after changes to alkalinity |
| | chemical or significant changes to the dose. |
| Centrate | The reduction of soluble phosphorus in the centrate |
| Transmissions | return reduces the likelihood of nuisance struvite |
| | production, protecting the pipes and infrastructure |
| | against scale. |
| Secondary | The reduction of return nitrogen helps to stabilize the |
| Treatment | nitrogen removal process in the activated sludge system, |
| | improving the BNR process and lowering the effluent |
| | nitrogen concentration while also reducing chemical |
| | carbon addition. The reduction of phosphorus in the |
| | return centrate helps to optimize phosphorus removal |
| | of the BNR process and reduce reliance on chemical |
| | addition at the tertiary filters. |

What is claimed is:

1. A method of reducing nitrogen and phosphorus recycled back to a liquid stream, the method comprising subjecting digested sludge to a post aerobic digestion (PAD) treatment process in the presence of calcium hydroxide.

2. The method of claim 1, wherein the PAD treatment process comprises cyclically driving nitritation and denitritation of digested sludge.

3. The method of claim 2, wherein the nitritation is driven by ammonium oxidizing bacteria (AOB).

4. The method of claim 2, wherein the denitritation is driven by heterotrophic bacteria.

5. The method of claim 1, wherein the PAD treatment process in the presence of calcium hydroxide removes at least 50% of phosphate from the digested sludge.

6. The method of claim 5, wherein the phosphate is removed through precipitation of calcium phosphate.

7. The method of claim 6, where the calcium phosphate precipitate is brushite, hydroxyapatite, or a combination thereof.

8. The method of claim 1, wherein the PAD treatment process in the presence of calcium hydroxide decreases PAD effluent orthophosphate concentration compared to the PAD treatment process in the absence of calcium hydroxide.

9. The method of claim 1, wherein the PAD treatment process in the presence of calcium hydroxide removes at least 80% of orthophosphate from the PAD effluent.

10. The method of claim 2, wherein the PAD treatment process in the presence of calcium hydroxide decreases PAD effluent nitrogen concentration compared to the PAD treatment process in the absence of calcium hydroxide.

11. The method of claim 2, wherein the presence of calcium hydroxide stabilizes pH for cyclic nitrification/denitrification.

12. The method of claim 11, wherein the stabilized pH ranges from 5.9 to 6.3.

13. The method of claim 1, wherein the PAD treatment process performed in a PAD reactor tank in the presence of calcium hydroxide decreases a foam layer within the PAD reactor tank compared to the PAD treatment process performed in the PAD reactor tank in the absence of calcium hydroxide.

14. The method of claim 13, wherein the foam layer within the PAD reactor tank during the PAD treatment process in the presence of calcium hydroxide is less than 0.1 feet.

15. The method of claim 13, wherein the decreased foam layer within the PAD reactor tank during the PAD treatment process in the presence of calcium hydroxide increases operating volume in the PAD reactor tank compared to the operating volume in a PAD rector tank wherein a PAD treatment process in the absence of calcium hydroxide is performed.

16. The method of claim 1, wherein the PAD treatment process performed in the presence of calcium hydroxide stabilizes the nitrogen removal process in the activated sludge system.

17. The method of claim 1, wherein the PAD treatment process performed in the presence of calcium hydroxide reduces reliance on chemical addition at least one tertiary filter compared to the PAD treatment process performed in the absence of calcium hydroxide.

18. The method of claim 6, wherein the calcium phosphate precipitates are separated from sludge after treatment to produce a separate product.

19. The method of claim 1, wherein the PAD treatment process performed in a PAD reactor tank in the presence of calcium hydroxide decreases nitrous oxide emissions from the PAD reactor tank compared to the PAD treatment process performed in the PAD reactor tank in the absence of calcium hydroxide.

20. The method of claim 19, wherein the PAD treatment process performed in a PAD reactor tank in the presence of calcium hydroxide attenuates greenhouse gas effects by reducing nitrous oxide emissions from the PAD reactor.
